(19) United States
(12) Patent Application Publication
(10) Pub. No.: US 2012/0056789 A1
(43) Pub. Date: Mar. 8, 2012

(54) ANTENNA BOOSTER CASE FOR ENHANCING TRANSMISSION/RECEPTION SENSIBILITY OF MOBILE DEVICE

(75) Inventor: Mike Sohn, La Habra, CA (US)

(73) Assignee: XG SOLUTIONS, LLC., Irvine, CA (US)

(21) Appl. No.: 12/882,102

(22) Filed: Sep. 14, 2010

Related U.S. Application Data
(60) Provisional application No. 61/380,118, filed on Sep. 3, 2010.

(51) Int. Cl. H01Q 1/24

(52) U.S. Cl. 343/702

(57) ABSTRACT

Disclosed is an antenna booster case for mobile devices for preventing death grip in a mobile device with an internal antenna, which has become a significant issue in recent years. More particularly, the present disclosure relates to an antenna booster case for mobile devices, which includes a case antenna provided to a protective case body, enclosing an outer surface of a mobile device, to be connected to an internal antenna of the mobile device through physical contact therewith or without physical contact therewith to enhance transmission/reception sensitivity of the mobile device. The antenna booster case includes a protective case body enclosing an outer surface of a mobile device; and a case antenna including a loop member secured to the protective case body and a connection part brought into contact with a conductive frame of the mobile device.

### CROSS-REFERENCE TO RELATED APPLICATION

This application claims the benefit of earlier filing date of U.S. Provisional Patent Application No. 61/380,118, filed Sep. 3, 2010, which is hereby incorporated herein by reference in its entirety.

### BACKGROUND

1. Technical Field

The present disclosure relates to a protective case for mobile devices.

2. Description of the Related Art

Mobile devices such as mobile phones, tablet PCs, iPads, etc., include internal antennae for 3G connection. In the recently introduced iPhone 4, a conductive frame is provided to an outer case and serves as an antenna to enhance transmission/reception performance. However, such a structure of the iPhone 4 suffers from a death grip phenomenon, that is, rapid deterioration in transmission/reception sensitivity of radio waves, depending on grip conditions. Here, the term “death grip” refers to a phenomenon in which the performance of a mobile device is deteriorated due to increases in shift and loss of frequencies when a user touches a conductive frame of the mobile device or grips a portion of the mobile device having an internal antenna therein to cover the antenna. Therefore, there is a need to provide an antenna booster case capable of preventing the mobile device from suffering from the death grip phenomenon while enhancing transmission/reception performance of the mobile device. The foregoing discussion is solely to provide background of the invention and does not constitutes an admission of prior art.

### BRIEF SUMMARY

One aspect of the present disclosure is to provide an antenna booster case for mobile devices, which prevents a user's body from touching a conductive frame constituting an outer case of the mobile device, thereby preventing deterioration in transmission/reception performance resulting from contact between the mobile device and the user's body.

Another aspect of the present disclosure is to provide an antenna booster case for mobile devices, which is separately attached to a mobile device and includes a case antenna embedded in the antenna booster case to prevent death grip, thereby enhancing transmission/reception performance of the mobile device.

A further aspect of the present disclosure is to provide an antenna booster case for mobile devices, which includes a protective case body, an antenna frame integrated into the protective case body by insert molding, and a case antenna integrated into the antenna frame by insert molding.

According to one aspect of the present disclosure, an antenna booster case for mobile devices includes a protective case body enclosing an outer surface of a mobile device; and a case antenna including a loop member secured to the protective case body and a connection part brought into contact with a conductive frame of the mobile device.

The case antenna may include a plurality of loop members. Here, the case antenna may include a plurality of contact type connection parts connected to the conductive frame through physical contact with the conductive frame. Alternatively, the case antenna may include a plurality of non-contact type connection parts connected to the conductive frame without physical contact with the conductive frame.

The case antenna may be secured to the protective case body in a state of being buried inside the antenna frame. The case antenna may be made of a flexible printed circuit board (FPCB), a metal sheet, or a conductive material. The case antenna may be integrated into the antenna frame via insert molding. The antenna frame may be integrated into the protective case body via insert molding.

The protective case body may include a main body made of a synthetic resin and an elastic rubber body coupled to the main body. Here, the main body may be coupled to the rubber body by fitting or integrally formed with the rubber body via insert injection-molding. The rubber body may be disposed on an outer surface of the connection part to impart elasticity to the connection part to force the connection part into close contact with the mobile device.

As such, according to one embodiment, the antenna booster case for mobile devices includes a case antenna electrically connected to a conductive frame, which is connected to an internal antenna of the mobile device, thereby preventing death grip while enhancing transmission/reception performance of the mobile device.

### BRIEF DESCRIPTION OF THE DRAWINGS

FIG. 1 is a perspective view of an antenna booster case for mobile devices, which includes a case antenna, according to one exemplary embodiment of the present disclosure;

FIG. 2 is an exploded perspective view of the antenna booster case for mobile devices according to the embodiment of the present disclosure;

FIG. 3 shows one embodiment of a connection structure between the mobile device and the connecting part of the case antenna of the antenna booster case according to the present disclosure;

FIG. 4 shows another embodiment of a connection structure between the mobile device and the connecting part of the case antenna of the antenna booster case according to the present disclosure; and

FIG. 5 is a graph representing VSWR data comparing an antenna booster case for mobile devices according to the present disclosure with a conventional antenna booster case.

### DETAILED DESCRIPTION OF EMBODIMENTS

Embodiments of the present disclosure will now be described in detail with reference to the accompanying drawings.

The above and other features and advantages of the present disclosure will become apparent from the detailed description of the following embodiments in conjunction with the accompanying drawings. It should be understood that the present disclosure is not limited to the following embodiments and may be embodied in different ways, and that the embodiments are given to provide complete disclosure of the invention and to provide thorough understanding of the present disclosure to those skilled in the art. The scope of the present disclosure is limited only by the accompanying claims and equivalents thereof.

The present disclosure relates to an antenna booster case having a case antenna, which may enhance antenna performance of a mobile device having an internal antenna.

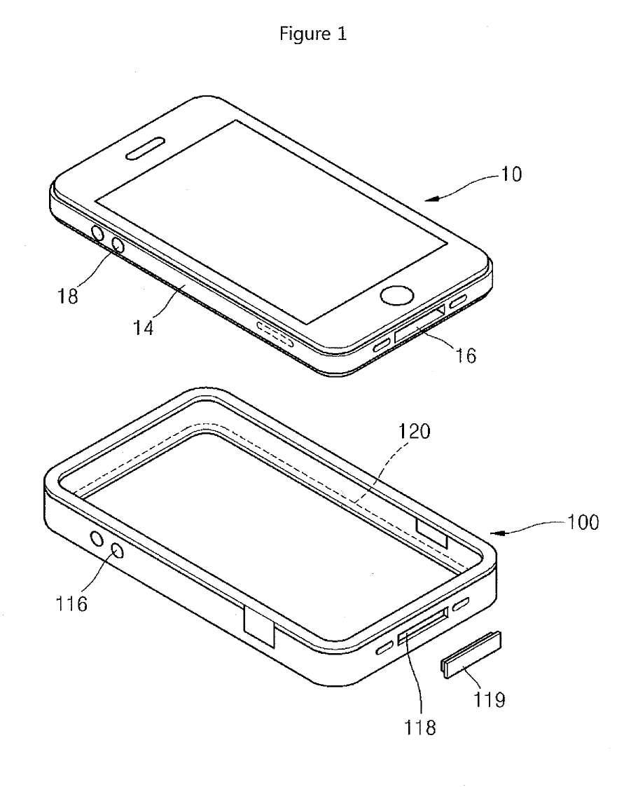

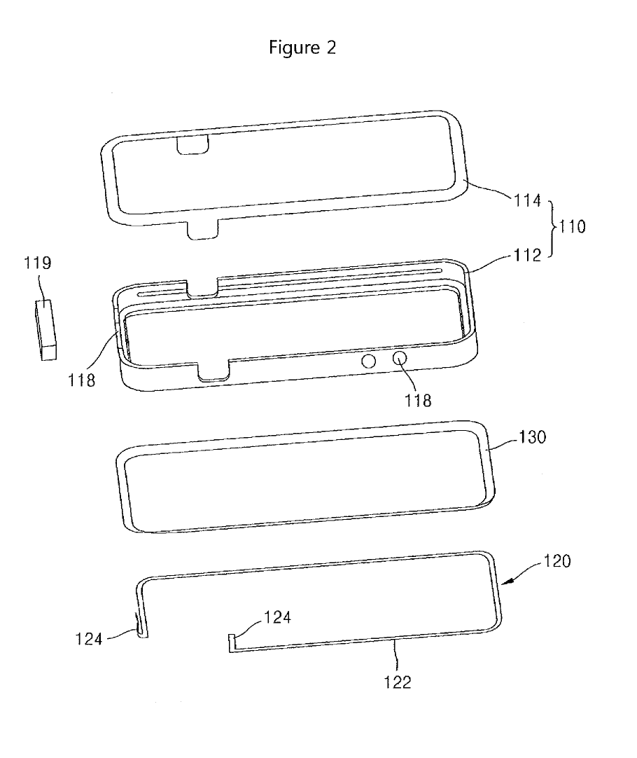

FIG. 1 is a perspective view of an antenna booster case for mobile devices, which includes a case antenna, according to one exemplary embodiment, and FIG. 2 is an exploded perspective view of the antenna booster case according to the embodiment.

Referring to FIG. 1, a mobile device 10 includes an internal antenna 12, which is electrically connected to a conductive frame 14 constituting an outer case of the mobile device 10. This structure is designed to enhance signal radiation from the internal antenna through the conductive frame 14 disposed on an outer surface of the mobile device.

The mobile device 10 is also provided with a charging terminal 16 and a button 18 for manipulation of the mobile device. Here, the charging terminal 16 may be connected to a charging cable and a PC connection cable.

According to one embodiment, an antenna booster case 100 for mobile devices acts as a protective case which will be coupled to the mobile device 10 to enclose and protect the mobile device 10 from damage, and as an antenna booster which includes a case antenna 120 connected to the conductive frame 14 of the mobile device 10 to enhance transmission/reception performance of the mobile device 10.

The case antenna 120 may include a contact type connection part, which will be connected to the conductive frame 140 through physical contact therewith, or a non-contact type connection part, which will be connected to the conductive frame 140 without physical contact therewith. The non-contact type connection part is configured to be connected to the conductive frame 140 via coupling.

According to the embodiment, the antenna booster case 100 includes a button part 116 formed at a portion of the antenna booster case corresponding to the button 18 of the mobile device 10 and a terminal part 118 formed at a portion of the antenna booster case corresponding to the charging terminal 16 of the mobile device 10.

The button part 116 allows a user to manipulate the button 18 with the antenna booster case 100 attached to the mobile device 10 and may be provided to a rubber body described below.

The terminal part 118 allows a user to connect the mobile device 10 to the charging cable or PC connection cable with the antenna booster case 100 attached to the mobile device 10 and may further include a terminal cap 119 detachably attached to the terminal part 118.

In the embodiment of FIG. 1, an iPhone 4 is shown as the mobile device, but the present disclosure is not limited thereto. The antenna booster case according to the present disclosure may be applied to any kind of mobile device so long as the mobile device includes a conductive frame and an internal antenna.

Referring to FIG. 2, the antenna booster case 100 according to the embodiment includes the case antenna 120, an antenna frame 130 enclosing the case antenna 120, and a protective case body 110 enclosing the antenna frame 140 and including a main body 112 and a rubber body 114.

The protective case body 110 may be made of a single material. Alternatively, the protective case body 110 may be formed by fitting the main body 112 and the rubber body 114 to each other. Alternatively, the protective case body 110 may be formed as a single body through insert-molding the main body 112 and the rubber body 114.

The rubber body 114 may be made of a highly elastic material so as to allow the mobile device to be easily fitted into the rubber body 114. Further, the rubber body 114 enhances grip and is provides an aesthetically pleasing appearance to the mobile device.

The case antenna 120 includes a loop member 122 embedded in the antenna frame 130 and a connection part 124 exposed on an inner surface of the protective case body 110 to be connected to the conductive frame 14 of the mobile device. In the embodiment of FIG. 2, the connection part 124 is a contact type connection part, which will be connected to the conductive frame 14 through physical contact with the conductive frame 14.

The antenna frame 130 encloses the loop member 122 of the case antenna 120 and is integrally formed with the case antenna 120 by insert molding. The antenna frame 130 serves to reinforce the case antenna 120 while preventing the loop member 122 of the case antenna 120 from contacting a user's body or the conductive frame of the mobile device. Further, the antenna frame 130 conceals the case antenna 120 to prevent the case antenna 120 from being exposed, such that the case antenna 120 is not visible from the outside. Considering that the antenna booster case needs to enhance the aesthetics of the mobile device as well as to protect the mobile device (by acting as the protective case), it is also very important to conceal the case antenna 120.

Further, the antenna frame 130 provides effects of preventing deformation or short circuit of the case antenna 120.

Coupling between the case antenna 120 and the antenna frame 130 may be realized by manufacturing the case antenna 120 and embedding the case antenna 120 in the antenna frame 130 through insert molding.

Here, the connecting part 124 of the case antenna 120 is exposed to the outside instead of being embedded in the antenna fame 130.

Further, the case antenna 120 is formed to be connected to the conductive frame which forms a portion of the outer case of the mobile device. Since the conductive frame of the mobile device is formed to be connected to an internal antenna of the mobile device, the case antenna 120 will be substantially connected to the internal antenna of the mobile device, thereby enhancing transmission/reception performance of the mobile device.

The main body 112 serves to protect a lateral side of the mobile device and the antenna frame 140, and to prevent separation of the main body 112 and rubber body 114 from the mobile device through coupling with the rubber body 114.

The main body 112 may be manufactured by injecting a material for the main body 112 into a mold in which the prepared antenna frame 130 is placed, that is, by insert molding.

The rubber body 114 serves to improve the grip of the antenna booster case and provide a pleasing appearance to the mobile device, while elastically supporting the connecting part 124 of the case antenna 120.

The rubber body 114 and the main body 112 may be prepared as separate members to be detachably coupled to each other. Alternatively, the rubber body 114 may be integrated into the main body 112 via insert molding after preparing the main body 112.

When the main body 112 and the rubber body 114 are integrally formed with each other, the main body 112 and the rubber body 114 may be combined with the mobile device by extending the rubber body 114 and fitting the mobile device into the extended rubber body 114.

The case antenna 120 may be made of a conductive material, such as a flexible printed circuit board (FPCB), a metal sheet, etc., by progressive bending.

The terminal cap 119 may be separately formed to be detachably attached to the terminal part 118. Alternatively, the terminal cap 119 may be integrally formed with the main body 112 or rubber body 114 by insert-molding a separate member having a structure capable of opening or closing the terminal part 118.

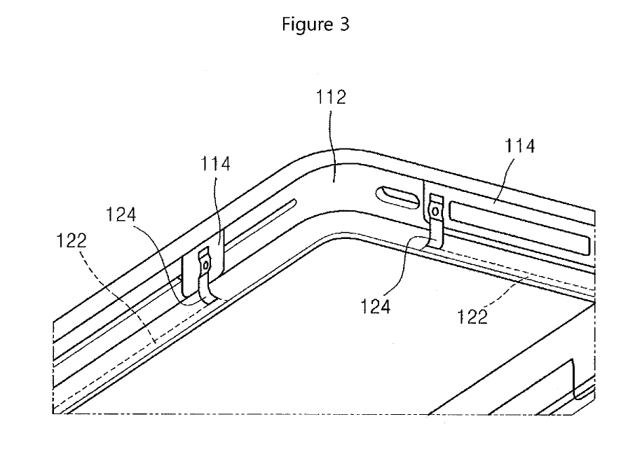

FIG. 3 shows one embodiment of a connection structure between the mobile device and connecting parts of the case antenna of the antenna booster case according to the present disclosure.

As shown in FIG. 3, a portion of the outer case of the mobile device 10 is formed with the conductive frame 14, which is electrically connected to the internal antenna 12 (FIG. 1) of the mobile device.

As described above, the antenna booster case 100 for mobile devices according to the embodiment has the case antenna 120 therein, and the connecting part 124 is formed on the case antenna 120 to contact the conductive frame 14.

Therefore, simply by coupling the antenna booster case 100 to an outer surface of the mobile device 10, the case antenna 120 is electrically connected to the internal antenna 12 of the mobile device, so that electric current is dispersed to the case antenna 120 instead of being concentrated on a power supply of the mobile device, thereby enhancing transmission/reception performance of the mobile device.

Death grip generally occurs when the conductive frame 14 connected to the internal antenna of the mobile device directly contacts a user's hand and interferes with transmission/reception through the internal antenna. Use of the antenna booster case 100 according to the present disclosure may prevent the occurrence of death grip.

In the antenna booster case 100 of the embodiment, the main body 112 and the rubber body 114, which will be brought into direct contact with a user's hand, are formed of a non-conductive material, and the case antenna 120 is enclosed by the antenna frame 130, thereby eliminating a possibility of contact between a user's hand and the conductive frame or case antenna. Consequently, the antenna booster case 100 may prevent the occurrence of death grip.

In this embodiment, the rubber body 114 is disposed on an outer surface of the connection part 124 to prevent the connection part 124 from damaging or scratching the outer case of the mobile phone 10 while imparting more elasticity to the connection part 124.

The connection part 124 is made of a metal sheet and is configured to be subjected to elastic force from the rubber body 114 in a direction of being brought into close contact with the conductive frame 14 by elasticity of the connection part 124.

In this embodiment, the rubber body 114 is disposed on the outer surface of each connection part 124 to impart elastic force to the connection part 124 so that the rubber body 124 forces the connection part 124 to be brought into close contact with the conductive frame 14.

As such, the connecting part 124 is brought into contact with the conductive frame 14 of the mobile device due to the elasticity of the connecting part 124. Here, the rubber body 114 covers the outer surface of the connecting part 124, so that flexibility of the connecting part 124 is guaranteed.

In the embodiment of FIG. 3, the connecting part 124 utilizes a two-point contact scheme. Alternatively, the connecting part 124 may utilize a 1-point contact scheme or a 3 or more-point contact scheme.

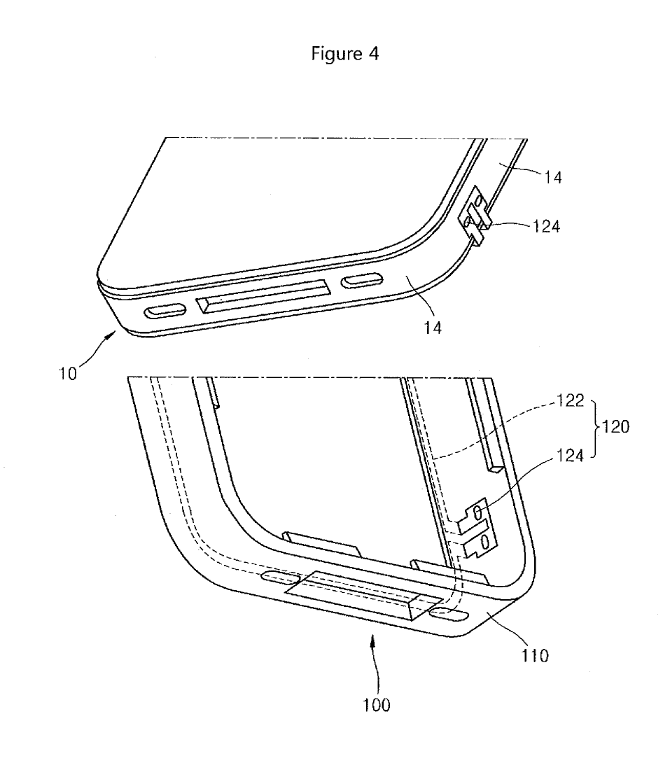

FIG. 4 shows another embodiment of a connection structure between the mobile device and the connecting part of the case antenna of the antenna booster case according to the present disclosure.

In the above embodiment, contact points of the connection part 124 are separated from each other and the rubber body 114 is formed on the outer surface of each connection part 124. In this embodiment, the connection part 124 includes a pair of adjacent contact points, and, instead of the rubber body 114, the main body 112 is disposed on an outer surface of the connection part 124.

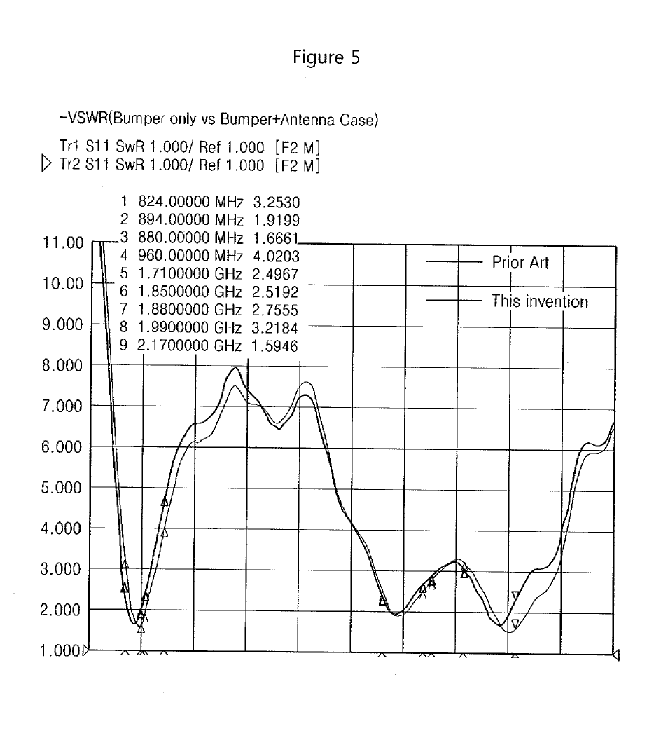

FIG. 5 is a graph representing VSWR data comparing an antenna booster case for mobile devices according to the present disclosure with a conventional antenna booster case.

For a conventional protective case for a mobile device, substantial deterioration in VSWR occurs at low frequencies when a user grips the mobile device.

On the other hand, according to the present disclosure, the antenna booster case including the case antenna allows convenient tuning of a resonant frequency and is capable of securing a bandwidth in a particular band, thereby improving performance of the mobile device in both a non-gripped state and a gripped state of the mobile device as compared with mobile devices which do not employ the antenna booster case of the present disclosure.

As such, when the antenna booster case according to the present disclosure is coupled to a mobile device, the case antenna in the antenna booster case is connected to an internal antenna of the mobile device, thereby enhancing transmission/reception performance of the mobile device.

Since the case antenna is embedded in the antenna booster case according to the present disclosure by any method such as insert molding or assembly, the case antenna may be connected to the internal antenna of the mobile device simply by coupling the antenna booster case to the mobile device.

Since the case antenna is embedded in the antenna booster case to be connected to the conductive frame of the mobile device inside the antenna booster case and not to contact other portions of the mobile device, it is possible to reduce performance deterioration due to contact with a user's body.

Although the present disclosure has been illustrated with reference to some embodiments in conjunction with the drawings, it will be apparent to a person having ordinary knowledge in the art that the embodiments are given by way of illustration only and do not limit the scope of the present disclosure in view of all aspects, and that various modifications and changes can be made without departing from the spirit and scope of the present disclosure. The scope of the present disclosure should be limited only by the accompanying claims.

What is claimed is:

1. An antenna booster case for a mobile device, comprising:
a protective case body configured to engage with a mobile device and to cover an outer surface of the mobile device; and
a case antenna including a loop member secured to the protective case body and a connection part configured to contact a conductive frame of the mobile device.

2. The antenna booster case of claim 1, wherein the case antenna comprises a plurality of loop members.

3. The antenna booster case of claim 1, wherein the case antenna comprises a plurality of contact type connection parts configured for electrical connection with the conductive frame through physical contact with the conductive frame.

4. The antenna booster case of claim 1, wherein the case antenna comprises a plurality of non-contact type connection parts configured for electrical connection with the conductive frame without physical contact with the conductive frame.

5. The antenna booster case of claim 1, further comprising an antenna frame, wherein the loop member is buried between the antenna frame and the protective case body.

6. The antenna booster case of claim 5, wherein the case antenna is integrated with the antenna frame via insert molding.

7. The antenna booster case of claim 5, wherein the antenna frame is integrated with the protective case body via insert molding.

8. The antenna booster case of claim 1, wherein the case antenna comprises a flexible printed circuit board (FPCB), a metal sheet, or a conductive material.

9. The antenna booster case of claim 1, wherein the protective case body comprises a main body made of a synthetic resin and an elastic rubber body coupled to the main body.

10. The antenna booster case of claim 9, wherein the main body is coupled to the rubber body by fitting.

11. The antenna booster case of claim 9, wherein the main body is integrally formed with the rubber body via insert injection-molding.

12. The antenna booster case of claim 9, wherein rubber body is disposed on an outer surface of the connection part to impart elasticity to the connection part to force the connection part into close contact with the mobile device.

13. The antenna booster case of claim 1, wherein the protective case body comprises a button formed at a portion of the protective case body corresponding to a button of the mobile device and an opening formed at a portion of the protective case body corresponding to a charging terminal of the mobile device.

14. The antenna booster case of claim 13, wherein the protective case body further comprises a cap removably engaged with the opening.

15. The antenna booster case of claim 1, wherein the loop member does not form a closed loop.

16. The antenna booster case of claim 1, wherein the loop member forms a closed loop around the mobile device when the mobile device is properly engaged with the protective case body.

17. A protective case of a mobile telecommunication device, the case comprising:
a protective case body configured to engage with a mobile telecommunication device comprising a conductive surface functioning as an antenna;
an antenna provided in the protective case body; and
at least one terminal of the antenna configured to contact the conductive surface of the mobile telecommunication device when the mobile telecommunication device is properly received by the protective case body.

18. The protective case of claim 17, wherein the protective case body comprises narrow sides that in combination form a closed loop and cover narrow side surfaces of the mobile telecommunication device when the mobile telecommunication device is properly engaged with the protective case, wherein the antenna comprises an electrically conductive wiring that extends along at least part of the narrow sides of the protective case body.

19. The protective case of claim 17, wherein the antenna is substantially buried between the protective case and an electrically insulating material layer.

20. The protective case of claim 19, wherein the at least one terminal is exposed out of the insulating material layer for making contact with the conductive surface of the mobile telecommunication device.
